(19) United States
(12) Patent Application Publication
(10) Pub. No.: US 2020/0119366 A1
(43) Pub. Date: Apr. 16, 2020

(54) CERAMIC COMPOSITE FOR FUEL CELL ANODE AND METHOD FOR PREPARING THE SAME

(71) Applicant: KOREA INSTITUTE OF SCIENCE AND TECHNOLOGY, Seoul (KR)

(72) Inventors: Ji-Won SON, Seoul (KR); Jung hoon PARK, Seoul (KR); Jongsup HONG, Seoul (KR); Hyoungchul KIM, Seoul (KR); Kyung Joong YOON, Seoul (KR); Jong Ho LEE, Seoul (KR); Hae-Weon LEE, Seoul (KR); Byung Kook KIM, Seoul (KR)

(21) Appl. No.: 16/712,272

(22) Filed: Dec. 12, 2019

Related U.S. Application Data
(63) Continuation of application No. 15/246,695, filed on Aug. 25, 2016.

(30) Foreign Application Priority Data
Jun. 15, 2016 (KR) 10-2016-0074404

(51) Int. Cl. H01M 4/88; H01M 4/90; C04B 35/50; C04B 35/453

(52) U.S. Cl. CPC H01M 4/8867; H01M 4/9075; C04B 35/50; H01M 2004/8684; H01M 4/9066; H01M 4/8885; C04B 35/453

(57) ABSTRACT

A ceramic composite for a fuel cell anode is disclosed. A method for preparing the metal-ceramic composite for a fuel cell anode, the metal-ceramic composite including (i) metal catalyst nanoparticles and (ii) a mixed-conductive ceramic, comprising (A) co-depositing a metal catalyst raw material and a mixed-conductive ceramic by physical vapor deposition. The metal catalyst raw material is present in an amount such that the content of the metal catalyst nanoparticles in the metal-ceramic composite is significantly lower than in conventional metal-ceramic composites. The presence of a small amount of the metal catalyst nanoparticles in the metal-ceramic composite minimizes the occurrence of stress resulting from a change in the volume of the metal catalyst and provides a solution to the problem of defects, achieving improved life characteristics. Also disclosed is a method for preparing the metal-ceramic composite.

### CROSS-REFERENCE TO RELATED APPLICATIONS

The present application is a continuation application of co-pending U.S. patent application Ser. No. 15/246,695, filed on Aug. 25, 2016 and titled, “METAL-CERAMIC COMPOSITE FOR FUEL CELL ANODE AND METHOD FOR PREPARING THE SAME”, which claims priority under 35 U.S.C. § 119 to Korean Patent Application No. 10-2016-0074404 filed on Jun. 15, 2016 in the Korean Intellectual Property Office, the disclosure of which is incorporated herein by reference in its entirety.

### BACKGROUND OF THE INVENTION

### 1. Field of the Invention

The present invention relates to a metal-ceramic composite. More specifically, the present invention relates to a metal-ceramic composite in which the metal content is greatly reduced such that the metal particles are arranged at uniform intervals, remain sufficiently far apart to prevent their aggregation, and are reduced to a nanometer scale in size, resulting in an increase in active surface area, and the ceramic has mixed conductivity, achieving improved activity and conductivity. The present invention also relates to a method for preparing the metal-ceramic composite.

### 2. Description of the Related Art

Solid oxide fuel cells (hereinafter also referred to as “SOFCs”) are fuel cells that use a solid oxide electrolyte through which oxygen ions can pass. SOFCs operate at the highest temperature (between 800 and 1000° C.) compared to existing fuel cells.

The most commonly used materials for anodes of such SOFCs are metal-ceramic composites prepared by mixing a metal catalyst with a ceramic material. Ni-YSZ is a representative composite for SOFC anodes.

The composite is prepared by reduction of NiO-YSZ. First, the NiO-YSZ is prepared by sintering and a SOFC employing the NiO-YSZ is fabricated. When the SOFC operates by fuel supply at a high temperature, the NiO is reduced to Ni. During this process, an electrical conductivity and a porous structure of the composite can be obtained.

When the SOFC operation is finished to stop the fuel supply, the Ni is again oxidized to NiO. During this reoxidation, the composite experiences volume expansion. As a result, the composite is structurally stressed, which becomes a cause of defects in the cell.

Many methods are currently under study to solve such problems. One of these methods is to provide anodes composed of only ceramics in order to avoid metal oxidation at high temperature. Ceramic composites for SOFC anodes are required to possess several fundamental characteristics, such as high electronic conductivity, excellent catalytic characteristics, and good stability at low oxygen partial pressure. However, ceramic composites reported to date fail to meet all of the requirements. Some of these ceramic composites are stable to some extent but suffer from poor performance compared to metal-ceramic composites.

For a SOFC, a cathode and an anode should have high porosities and an electrolyte is required to have a dense structure. Thus, individual high temperature sintering processes are needed for the production of the respective elements. In this case, however, the different sintering temperatures cause distortion between the elements, incurring a rise in processing cost.

The inevitable high temperature sintering processes cause unnecessary reactions between the electrolyte and the electrode materials in high-temperature environments, and as a result, many problems arise, for example, undesirable impurities are formed in the electrolyte.

As a solution to the above-described problems, a novel anode for a solid oxide fuel cell is needed that has improved stability and performance and that can be prepared without sintering.

### PRIOR ART DOCUMENTS

### Patent Documents

1. Korean Patent Publication No. 10-2014-0048738

### SUMMARY OF THE INVENTION

The present invention has been made in view of the above problems, and it is one object of the present invention to provide a metal-ceramic composite for a fuel cell anode that can be prepared without sintering and is excellent in activity and performance despite its low metal catalyst content.

It is a further object of the present invention to provide a method for preparing the metal-ceramic composite on amass production.

One aspect of the present invention provides a metal-ceramic composite for a fuel cell anode including metal catalyst nanoparticles and a mixed-conductive ceramic wherein the metal catalyst nanoparticles are included in an amount of 1 to 5% by volume, based on the total volume of the metal-ceramic composite, and the metal-ceramic composite is prepared by co-deposition of a raw material for the metal catalyst and the mixed-conductive ceramic by means of physical vapor deposition.

A further aspect of the present invention provides a fuel cell or power generation device including the metal-ceramic composite.

Another aspect of the present invention provides a method for preparing a metal-ceramic composite, including (A) co-depositing a metal catalyst raw material and a mixed-conductive ceramic by physical vapor deposition (PVD).

The metal-ceramic composite of the present invention includes a mixed-conductive ceramic and a significantly smaller amount of metal catalyst nanoparticles than conventional metal-ceramic composites. The presence of a small amount of the metal catalyst nanoparticles minimizes the occurrence of stress resulting from a change in the volume of the metal catalyst and provides a solution to the problem of defects, achieving improved life characteristics.

In addition, the metal-ceramic composite of the present invention is prepared by co-deposition of metal catalyst nanoparticles and a ceramic by means of physical vapor deposition without sintering. As a result, the metal catalyst nanoparticles are arranged at uniform intervals in the metal-ceramic composite and are thus prevented from aggregating even at high temperature, allowing the metal-ceramic composite to maintain its high performance for a long period of time.

Furthermore, since the method of the present invention does not require high-temperature sintering, it can provide a solution to the problems encountered with conventional solid oxide fuel cells (for example, impurities between electrodes and electrolytes, defects, and high costs during sintering).

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a conceptual diagram showing the structural features of a metal-ceramic composite according to the present invention;

FIG. 2 is a conceptual diagram showing the structural features of a conventional metal-ceramic composite;

FIG. 3 is a cross-sectional view illustrating the structure of a solid oxide fuel cell employing a metal-ceramic composite of the present invention;

FIG. 4 is a flowchart illustrating a method for preparing a metal-ceramic composite according to one embodiment of the present invention;

FIGS. 5a and 5b are SEM images of a metal-ceramic composite prepared in Comparative Example 1 before and after reduction, respectively;

FIG. 6a is a SEM image of a metal-ceramic composite prepared in Comparative Example 2 before reduction and FIG. 6b shows SEM and TEM images of the metal-ceramic composite after reduction;

FIG. 7a is a SEM image of a metal-ceramic composite prepared in Example 1 before reduction and FIG. 7b shows SEM and TEM images of the metal-ceramic composite after reduction;

FIG. 8 shows the current-voltage-power characteristics of a unit cell fabricated using a metal-ceramic composite prepared in Comparative Example 3 and a unit cell fabricated using a metal-ceramic composite prepared in Example 1, which were measured at temperatures at 600° C.;

FIG. 9 shows impedance spectra for a unit cell fabricated using a metal-ceramic composite prepared in Comparative Example 3 and a unit cell fabricated using a metal-ceramic composite prepared in Example 1; and

FIG. 10 shows changes in the power density (%) of a unit cell fabricated using a metal-ceramic composite prepared in Comparative Example 3 and a unit cell fabricated using a metal-ceramic composite prepared in Example 1 as a function of the number of RedOx cycles (n) to evaluate the long-term stability of the unit cells, which were measured at temperature at 600° C.

### DETAILED DESCRIPTION OF THE INVENTION

Several aspects and various embodiments of the present invention will now be described in more detail.

One aspect of the present invention is directed to a metal-ceramic composite for a fuel cell anode including metal catalyst nanoparticles and a mixed-conductive ceramic material wherein the metal catalyst nanoparticles are included in an amount of 1 to 5% by volume, based on the total volume of the metal-ceramic composite, and the metal-ceramic composite is prepared by co-deposition of a raw material for the metal catalyst and the mixed-conductive ceramic as separate targets or a mixture thereof as a single target by means of physical vapor deposition.

Examples of suitable physical vapor deposition techniques include, but are not limited to, pulsed laser deposition (PLD), sputtering, and E-beam evaporation.

According to the present invention, the microstructure of the metal-ceramic composite and the organic binding between a small amount of the metal catalyst nanoparticles and the ceramic material are improved. Due to the improved microstructure and organic binding, the problems of defects caused by a volume variation of the metal catalyst nanoparticles, aggregation of the metal catalyst nanoparticles, and impurities and defects between electrodes and an electrolyte during sintering can be solved.

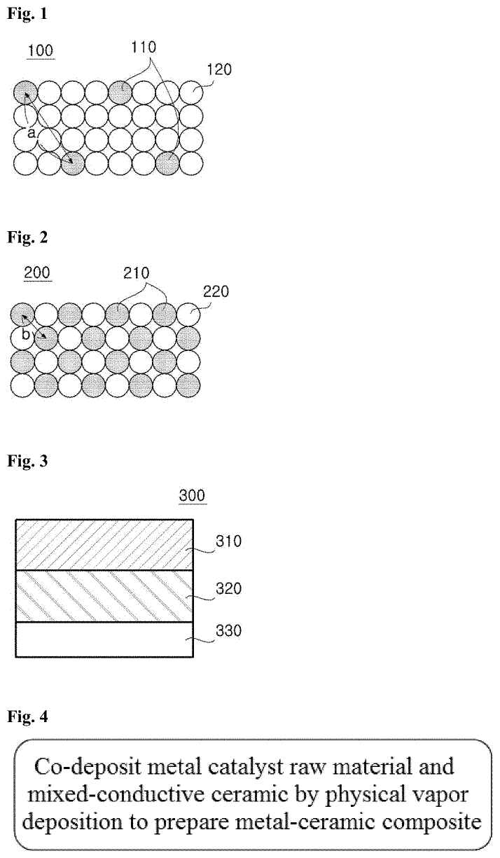

With reference to FIG. 1, a detailed explanation will be given of the structural features of the metal-ceramic composite according to the present invention.

FIG. 2 is a conceptual diagram showing the structural features of a conventional metal-ceramic composite. The conventional metal-ceramic composite 200 is prepared by sintering of a large amount of micrometer-sized metal catalyst nanoparticles 210 and a ceramic material at a high temperature, unlike the metal-ceramic composite shown in FIG. 1. The metal catalyst nanoparticles 210 are arranged uniformly in the metal-ceramic composite 200 but the adjacent metal catalyst nanoparticles 210 tend to aggregate during sintering or reduction. This aggregation causes many problems (e.g., defects and volume variation), leading to poor performance and life characteristics.

In the metal-ceramic composite shown in FIG. 1, metal catalyst nanoparticles 110 are homogenized with a mixed-conductive ceramic material 120. The metal catalyst nanoparticles 110 are present in an amount as small as 1 to 5% by volume, based on the total volume of the metal-ceramic composite. Thus, the average intervals between the metal catalyst nanoparticles 110 are maintained at a sufficient level, allowing the metal catalyst nanoparticles 110 to maintain their original size and intervals (FIG. 1) without aggregation even under repeated reduction.

It is very important that the metal-ceramic composite of the present invention meets the following requirements: (i) use of the mixed-conductive ceramic; (ii) adjustment of the amount of the metal catalyst nanoparticles to 1 to 5% by volume, based on the total volume of the metal-ceramic composite; (iii) co-deposition of the mixed-conductive ceramic and the metal catalyst nanoparticles by physical vapor deposition; and (iv) no annealing after deposition. If any one of the requirements is not met, the microstructure of the composite may vary or be defective or the metal catalyst nanoparticles may aggregate during reduction in the course of operation, resulting in considerable deterioration of cell performance.

Due to these structural features, the present invention can provide a solution to the inherent problems encountered with conventional metal-ceramic composites, such as coarsening, poor sinterability, low life, and defects at the interface between metal catalyst nanoparticles and ceramics.

The solution to the problems of coarsening, low life, and defects at the interface between metal catalyst nanoparticles and ceramics can be found in the Experimental Examples section that follows. Specifically, the metal-ceramic composite of the present invention has a power density of 90 to 99% even after 50-100 cycles.

However, there is a risk that the low content of the metal catalyst nanoparticles may deteriorate the catalytic activity and anode performance. According to the present invention, the risk can be avoided by the microstructure of the metal-ceramic composite prepared without sintering and the use of the mixed-conductive ceramic material, and further improved performance can be achieved.

The metal catalyst may be any of those commonly used in fuel cells but is preferably selected from, but not particularly limited to, Fe, Co, Ni, Cu, Ru, Rh, Pd, Ag, and oxides of these transition metals.

Ni is most preferred because it can be homogenized with the ceramic without the need for additional sintering, making the composite advantageous in terms of cost and performance.

As used herein, the term “mixed-conductive” means that the ceramic possesses both electronic and ionic conductivity. Any ceramic that has mixed conductivity may be used without particular limitation in the present invention. The mixed-conductive ceramic is preferably selected from the group consisting of doped cerias, such as gadolinium-doped ceria (GDC) and samarium-doped ceria (SDC), and doped-bismuth oxides, such as yttria-doped bismuth oxide (YDB).

The metal-ceramic composite may be prepared by co-deposition of a raw material for the metal catalyst and the mixed-conductive ceramic by means of physical vapor deposition. The metal-ceramic composite is highly resistant to a volume variation resulting from thermal expansion.

The physical vapor deposition enables faster and easier preparation of the metal-ceramic composite in which the metal catalyst nanoparticles are arranged at uniform intervals, as shown in FIG. 1, despite the use of a small amount of the metal catalyst raw material.

The preparation of the metal-ceramic composite does not require a subsequent high-temperature energy and cost-consuming sintering process.

In other words, co-deposition of the metal catalyst raw material and the mixed-conductive ceramic by means of physical vapor deposition is required to improve the microstructure of the metal-ceramic composite and the organic binding between the metal catalyst nanoparticles and the ceramic.

Sintering after physical vapor deposition is cost, energy, and time-consuming and coarsens the metal catalyst nanoparticles, leading to poor performance.

The metal catalyst nanoparticles are isotropically aligned between the mixed-conductive ceramic particles. This isotropic structure is maintained even after the metal-ceramic composite is applied to a fuel cell and is then reduced.

The metal-ceramic composite may be in the form of a thin film having a thickness of 1 to 15 μm. The thin metal-ceramic composite free of structural defects improves the binding between an anode and an electrolyte and the structural stability of a fuel cell. In addition, the metal-ceramic composite is prepared without sintering, leaving no impurities or interfacial defects, such as secondary phases, between an anode and an electrolyte.

The metal catalyst nanoparticles present in the metal-ceramic composite substantially maintain their size and intervals, preferably at a level of 90 to 99% of the original values, even after reduction.

During reduction of conventional metal-ceramic composites (FIG. 2 and Comparative Examples 1 and 2), metal catalyst nanoparticles aggregate, which varies their intervals and arrangement. Such variations cause various problems in terms of performance, life characteristics, and structural stability.

The present inventors have been aware of the above-described problems of conventional metal-ceramic composites and have made an effort to solve the problems, and as a result, found that the presence of a reduced amount of metal catalyst nanoparticles in a metal-ceramic composite improves the organic binding between the metal catalyst nanoparticles and the ceramic and the microstructure of the composite. It was also found that the metal-ceramic composite of the present invention has improved structural stability and catalytic performance without the need for sintering.

According to one embodiment of the present invention, the metal catalyst nanoparticles are included in an amount of 1 to 5% by volume, based on the total volume of the metal-ceramic composite, and the metal-ceramic composite is prepared by physical vapor deposition. The use of a greatly reduced amount of the metal catalyst nanoparticles maintains the microstructure of the metal-ceramic composite without degradation or destruction despite repeated changes of RedOx atmospheres.

The microstructure of the metal-ceramic composite is maintained uniform by the organic binding between the constituent components. Particularly, the intervals between the metal catalyst nanoparticles are maintained sufficiently large, as shown in FIG. 1. Therefore, the microstructure of the metal-ceramic composite is free of defects and the size of the metal catalyst nanoparticles can be maintained constant even after reduction.

The microstructure of the metal-ceramic composite is specifically shown in FIG. 1. Referring to FIG. 1, the metal catalyst nanoparticles having an isotropic structure are arranged between the mixed-conductive ceramic particles having a nanoporous columnar structure.

Since the metal-ceramic composite of the present invention can be prepared without sintering, it can be used to produce a fuel cell anode on a metal support or conductive support that is susceptible to annealing in an oxidizing atmosphere. Therefore, the metal-ceramic composite of the present invention is useful in a wide range of applications.

FIG. 3 is a cross-sectional view illustrating the structure of a solid oxide fuel cell employing the metal-ceramic composite of the present invention.

Referring to FIG. 3, the solid oxide fuel cell includes an anode 310, an electrolyte 320, and a cathode 330.

The anode 310 may include the metal-ceramic composite of the present invention.

The electrolyte 320 may be any of those commonly used in the art, for example, zirconias, cerias, and (La, Sr)(Ga, Mg)O₃ (LSGM). Specifically, the electrolyte 120 may be selected from stabilized zirconias, such as yttria-stabilized zirconia (YSZ) and scandia-stabilized zirconia (ScSZ), doped-cerias, such as gadolinia-doped ceria (GDC) and samaria-doped ceria (SDC), and mixtures thereof. In the case where (La, Sr)(Ga, Mg)O₃ (LSGM) is used as the electrolyte, the solid oxide fuel cell may further include an anode functional layer formed of GDC to prevent reaction with Ni.

The cathode 130 may be made of any material for SOFC cathodes that has high electrical conductivity while possessing high RedOx catalytic activity.

Another aspect of the present invention is directed to a method for preparing a metal-ceramic composite including (A) co-depositing a metal catalyst raw material and a mixed-conductive ceramic by physical vapor deposition (PVD).

FIG. 4 is a flowchart illustrating a method for preparing a metal-ceramic composite according to one embodiment of the present invention.

Referring specifically to FIG. 4, first, a metal catalyst raw material is mixed with a mixed-conductive ceramic to prepare a mixture.

The metal catalyst raw material may be any of those commonly used in fuel cells but is preferably an oxide of at least one transition metal selected from, but not particularly limited to, Fe, Co, Ni, Cu, Ru, Rh, Pd, and Ag.

Ni is most preferred because it can be homogenized with the ceramic without the need for sintering, making the final composite advantageous in terms of cost and performance.

Any ceramic that has mixed conductivity may be used without particular limitation in the method of the present invention. The mixed-conductive ceramic is preferably selected from the group consisting of doped cerias, such as gadolinium-doped ceria (GDC) and samarium-doped ceria (SDC), and doped-bismuth oxides, such as yttria-doped bismuth oxide (YDB).

In step (A), the metal catalyst raw material may be included in an amount of 1 to 5% by volume, based on the total volume of the mixture. The presence of the metal catalyst raw material in an amount of less than 1% by volume makes it impossible to achieve the desired effects of the present invention and deteriorates the performance of the metal-ceramic composite. Meanwhile, the presence of the metal catalyst raw material in an amount exceeding 5% by volume creates a variation or defects in the microstructure of the metal-ceramic composite during subsequent reduction, causes the metal catalyst nanoparticles to aggregate, and considerably deteriorates the stability and performance of a cell employing the metal-ceramic composite, as can be seen in the Experimental Examples section that follows.

In other words, the content of the metal catalyst raw material is limited to 1 to 5% by volume, based on the total volume of the metal-ceramic composite. The presence of the metal catalyst raw material in an amount of less than 1% by volume makes it impossible to achieve the desired effects of the present invention and deteriorates the performance of the metal-ceramic composite. Meanwhile, the presence of the metal catalyst raw material in an amount exceeding 5% by volume creates a variation or defects in the microstructure of the metal-ceramic composite during subsequent reduction, causes the metal catalyst nanoparticles to aggregate, and considerably deteriorates the stability and performance of a cell employing the metal-ceramic composite, as can be seen in the Experimental Examples section that follows.

Next, the mixture is deposited by physical vapor deposition to prepare the metal-ceramic composite.

The physical vapor deposition is performed using the mixture of the metal catalyst raw material and the mixed-conductive ceramic material as a target.

Alternatively, the metal catalyst raw material and the mixed-conductive ceramic material may be used as separate targets for the physical vapor deposition. The target (or targets) and a substrate are placed in a vacuum chamber where the target materials are vaporized into atoms, molecules, etc. with physical energy and are deposited on the substrate.

Particularly, the physical vapor deposition is advantageous in terms of processing and thickness control, allows uniform deposition of the metal catalyst nanoparticles without the need for additional sintering, and enables the preparation of the metal-ceramic composite free of defects between the ceramic and the metal catalyst nanoparticles.

As mentioned previously, the addition of a sintering process as in other powder processing-based film formation methods (for example, screen printing, spin coating, dip coating or drop coating after sintering) is cost-, energy-, and time-consuming and causes coarsening of the metal catalyst nanoparticles, leading to poor performance.

The preparation of the metal-ceramic composite does not require a subsequent high-temperature energy and cost-consuming sintering, contributing to significant cost and energy saving.

The present invention will be explained in more detail with reference to the following examples. However, these examples are not to be construed as limiting or restricting the scope and disclosure of the invention. It is to be understood that based on the teachings of the present invention including the following examples, those skilled in the art can readily practice other embodiments of the present invention whose experimental results are not explicitly presented. It will also be understood that such modifications and variations are intended to come within the scope of the appended claims.

The experimental results of the following examples, including comparative examples, are merely representative and the effects of the exemplary embodiments of the present invention that are not explicitly presented hereinafter can be specifically found in the corresponding sections.

### Example 1: Preparation of Ni-GDC Composite with Reduced Ni Content (2 vol %)

A powder of gadolinium-doped ceria (GDC) as a mixed-conductive ceramic material was mixed with a NiO powder as a raw material for metal catalyst nanoparticles. The NiO powder was used in such an amount that the content of Ni as a reduction product of the NiO was 2 vol %, based on the total volume of the mixture.

The mixture was deposited by physical vapor deposition to prepare a metal-ceramic (NiO-GDC) composite. The physical vapor deposition was performed with a pulsed laser deposition (PLD) system at an oxygen partial pressure of 50 mTorr, a laser density of 2.5 J/cm², and a frequency of 10 Hz. The NiO of the composite was subsequently reduced to Ni catalyst nanoparticles.

The mixture of the mixed-conductive ceramic material and the metal catalyst raw material was used as a target for the physical vapor deposition. Alternatively, the mixed-conductive ceramic material and the metal catalyst raw material may be used as individual targets.

### Comparative Example 1: Preparation of Ni-GDC Composite with 40 Vol % Ni

A metal-ceramic (NiO-GDC) composite was prepared in the same manner as in Example 1, except that the NiO powder was used in such an amount that the content of Ni as a reduction product of the NiO was 40 vol %, based on the total volume of the mixture.

### Comparative Example 2: Preparation of Ni-GDC Composite with 10 Vol % Ni

A metal-ceramic (NiO-GDC) composite was prepared in the same manner as in Example 1, except that the NiO powder was used in such an amount that the content of Ni as a reduction product of the NiO was 10 vol %, based on the total volume of the mixture.

### Comparative Example 3: Preparation of Post-Annealed Ni-GDC Composite with 40 vol % Ni

The NiO-GDC composite of Comparative Example 1 was post-annealed at 1200° C. for 1 h.

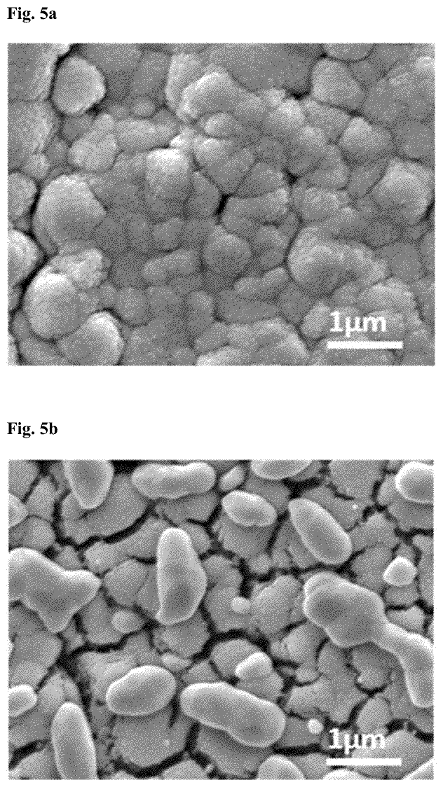

FIGS. 5a and 5b are SEM images comparing the surface structures of the metal-ceramic composite prepared in Comparative Example 1, in which a large amount of the metal catalyst nanoparticles was present, before (5a) and after reduction (5b).

The metal-ceramic composite was reduced by fuel supply at a high temperature of 600° C. for 10 h.

When the NiO particles of the metal-ceramic composite were reduced to Ni particles, the adjacent metal catalyst nanoparticles aggregated to a micrometer size, as confirmed in FIGS. 5a and 5b.

This size change demonstrates the formation of defects in the microstructure of the metal-ceramic composite.

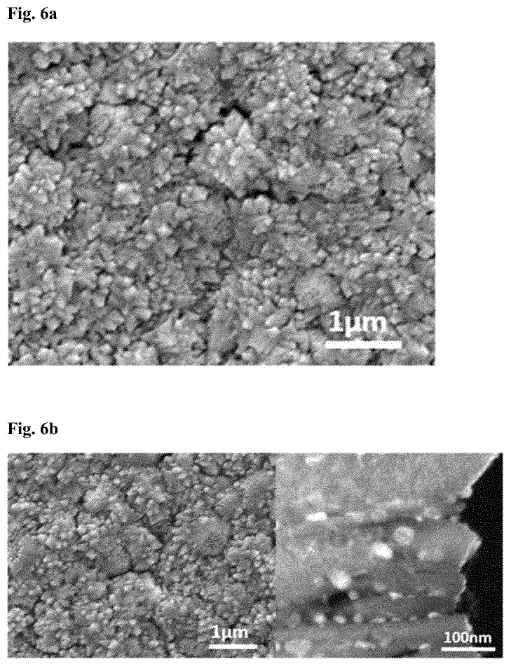

FIG. 6a is a SEM image of the metal-ceramic composite prepared in Comparative Example 2 before reduction and FIG. 6b shows SEM and TEM images of the metal-ceramic composite after reduction.

FIGS. 6a and 6b compare the surface structures of the metal-ceramic composite, in which a relative large amount of the metal catalyst nanoparticles was present compared to in the metal-ceramic composite prepared in Example 1, before and after reduction.

The metal-ceramic composite was reduced by fuel supply at a high temperature of 600° C. for 10 h.

The adjacent metal catalyst nanoparticles aggregated and grew into larger particles, as confirmed in FIGS. 6a and 6b.

This size change was smaller than that observed in the metal-ceramic composite of Comparative Example 1 but it also demonstrates the formation of defects in the microstructure of the metal-ceramic composite.

The defects change the microstructure of the metal-ceramic composite and induce significant differences in the performance and stability of a final fuel cell employing the metal-ceramic composite.

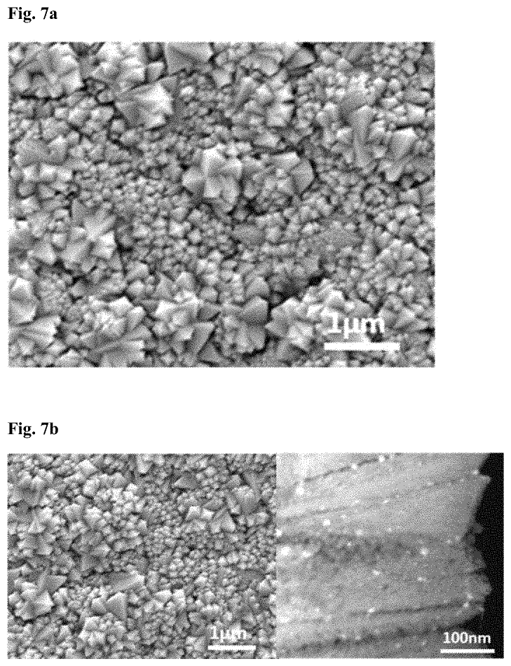

FIG. 7a is a SEM image of the metal-ceramic composite prepared in Example 1 before reduction and FIG. 7b shows SEM and TEM images of the metal-ceramic composite after reduction.

FIGS. 7a and 7b compare the surface structures of the metal-ceramic composite, in which a greatly reduced amount of the metal catalyst nanoparticles was present, before and after reduction.

The metal-ceramic composite was reduced by fuel supply at a high temperature of 600° C. for 10 h.

As shown in FIGS. 7a and 7b, isotropic Ni particles were arranged between the ceramic particles having a columnar structure in the metal-ceramic composite of Example 1 and remained almost unchanged in size even after reduction.

Specifically, the metal catalyst nanoparticles of the metal-ceramic composite maintained their size at 80-99% of the original size after reduction.

No substantial change in the microstructure of the metal-ceramic composite was observed before and after reduction.

Less Ni aggregation was observed in the metal-ceramic composite of Example 1 after reduction than in the metal-ceramic composites of Comparative Examples 1 and 2. This observation reveals that few or no defects were formed in the microstructure of the metal-ceramic composite of Example 1 by a change in the volume of the metal catalyst nanoparticles during repeated reduction.

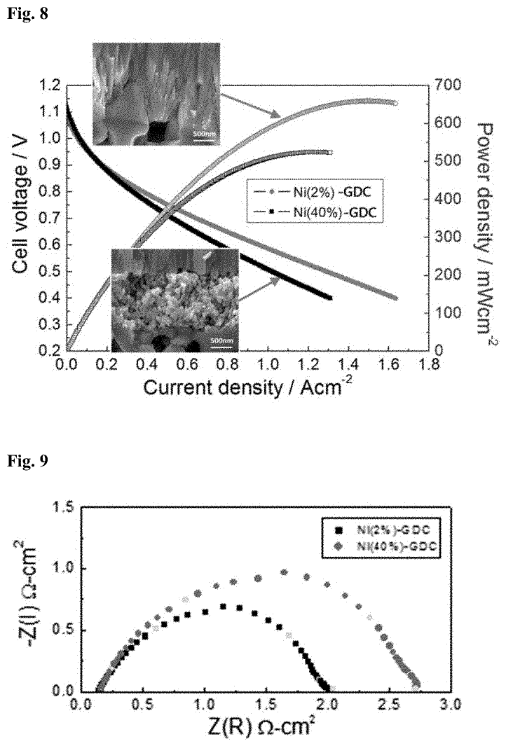

FIG. 8 shows the current-voltage-power characteristics of a unit cell fabricated using the metal-ceramic composites prepared in Comparative Example 3 and a unit cell fabricated using the metal-ceramic composites prepared in Example 1, which were measured at temperatures at 500° C.

Each unit cell was fabricated by the following procedure. First, a NiO-YSZ support was prepared by powder processing. Thereafter, the corresponding metal-ceramic composite was deposited to a thickness of 1 μm on the support by pulsed laser deposition (PLD) to form an anode. YSZ and GDC as electrolyte materials were deposited to thicknesses of 1 μm and 200 nm, respectively, on the anode and LSC was subsequently deposited to a thicknesses of 3 μm to form a cathode.

As shown in FIG. 8, the unit cell employing the metal-ceramic composite of Example 1 had a higher active site density than the unit cell employing the metal-ceramic composite of Comparative Example 3, indicating its increased performance.

Specifically, the unit cell employing the metal-ceramic composite of Comparative Example 3 including the excess metal catalyst nanoparticles had a maximum power density of 525 mW/cm², whereas the unit cell employing the metal-ceramic composite of Example 1 had a maximum power density of 659 mW/cm², which was approximately 1.25-fold higher than that of the unit cell employing the metal-ceramic composite of Comparative Example 3.

In other words, the metal-ceramic composite of Example 1 showed even better performance than the metal-ceramic composite of Comparative Example 3 despite the presence of a 20 times smaller amount of the metal catalyst nanoparticles.

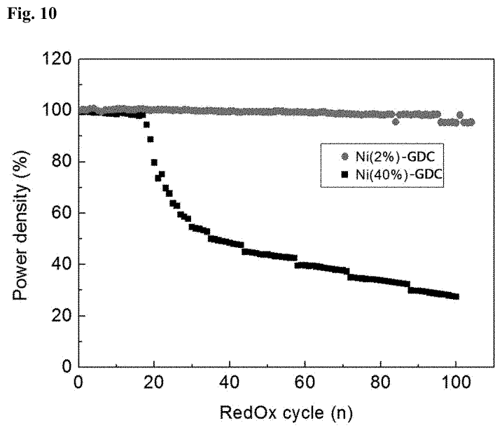

FIG. 9 shows impedance spectra for a unit cell employing the metal-ceramic composites prepared in Comparative Example 3 and a unit cell employing the metal-ceramic composites prepared in Example 1. The unit cells were fabricated in the same manner as those used in FIG. 8.

As shown in FIG. 9, the ohmic resistances of the unit cell employing the metal-ceramic composite of Comparative Example 3 including the excess metal catalyst nanoparticles were similar to those of the unit cell employing the metal-ceramic composite of Example 1.

These results indicate that the preparation method and microstructure of the metal-ceramic composite of Example 1 and the improved binding between the metal catalyst nanoparticles and the ceramic in the metal-ceramic composite contributed to sufficient electronic conductivity of the metal-ceramic composite although the content of the metal catalyst nanoparticles was 20 times lower than that in the metal-ceramic composite of Comparative Example 3.

FIG. 10 shows changes in the power density (%) of a unit cell fabricated using the metal-ceramic composites prepared in Comparative Example 3 and a unit cell fabricated using the metal-ceramic composites prepared in Example 1 as a function of the number of RedOx cycles (n) to evaluate the long-term stability of the unit cells, which were measured at temperature at 600° C.

Each unit cell was fabricated by the following procedure. First, a YSZ support was formed by powder processing. Thereafter, the corresponding metal-ceramic composite was deposited to a thickness of 1 μm on the support by pulsed laser deposition (PLD) to form an anode. LSC was deposited to a thickness of 3 μm opposite the anode to form a cathode.

This experiment was conducted to determine what actual influence different microstructures of the metal-ceramic composites observed in FIGS. 5 to 7 had on the performance of the cells under varying RedOx atmospheres.

The power density (%) was expressed as a percent of the power density measured at each cycle relative to the initial power density at 0-1 cycle.

The unit cell employing the metal-ceramic composite of Example 1 had a power density of 90-99% after 50-100 cycles. In contrast, the power density of the unit cell employing the metal-ceramic composite of Comparative Example 3 began to decrease after 20 cycles until it reached 20-40% at 50-100 cycles.

These results demonstrate that the metal-ceramic composite of the present invention maintains its structural stability for a long period of time without substantially losing its performance when applied to a fuel cell.

What is claimed is:

1. A method for preparing the metal-ceramic composite for a fuel cell anode, the metal-ceramic composite comprising (i) metal catalyst nanoparticles and (ii) a mixed-conductive ceramic, comprising (A) co-depositing a metal catalyst raw material and a mixed-conductive ceramic by physical vapor deposition.

2. The method according to claim 1, wherein the metal catalyst nanoparticles are present in an amount of 1 to 5% by volume, based on the total volume of the metal-ceramic composite.

3. The method according to claim 2, wherein the metal catalyst raw material is an oxide of at least one transition metal selected from Fe, Co, Ni, Cu, Ru, Rh, Pd, and Ag

4. The method according to claim 2, wherein the mixed-conductive ceramic is selected from gadolinium-doped ceria (GDC), samarium-doped ceria (SDC), yttria-doped bismuth oxide (YDB), and mixtures thereof.

5. The method according to claim 2, wherein no annealing is conducted after the co-depositing.
